(19) United States
(12) Patent Application Publication
(10) Pub. No.: US 2007/0205617 A1
(43) Pub. Date: Sep. 6, 2007

(54) EXTENDABLE LOAD CARRIER FOR VEHICLES, IN PARTICULAR PASSENGER VEHICLES

(75) Inventors: Gerald Hahn, Wistedt (DE); Thorsten Schumacher, Kummerfeld (DE); Eberhard Maucher, Ulm (DE); Sandro Hans, Wiesbaden (DE)

Correspondence Address: BROOKS KUSHMAN P.C., 1000 TOWN CENTER, TWENTY-SECOND FLOOR, SOUTHFIELD, MI, 48075, US

(73) Assignee: Magna Car Top Systems GmbH, Bietigheim-Bissingen (DE)

(21) Appl. No.: 11/469,140

(22) Filed: Aug. 31, 2006

(30) Foreign Application Priority Data
Aug. 31, 2005 (DE) 10 2005 041 540.7

(51) Int. Cl. B60R 19/40

(52) U.S. Cl. 293/119

(57) ABSTRACT

A rear load carrier, designed in particular as a bicycle carrier, for vehicles, primarily passenger vehicles, is telescopically extendable and has a guide profile and a support profile. The guide profile is fixed as an inner profile to the structure of the vehicle. The support profile rests on the guide profile as an overlapping, longitudinally displaceable profile having in particular a U-shaped cross section and being fixed to the guide profile by a clamping device. The clamping device passes through the longitudinally slotted upper flange of the guide profile and the bridge of the support profile.

### CROSS-REFERENCE TO RELATED APPLICATIONS

This application claims foreign priority benefits under 35 U.S.C. § 119(a)-(d) to DE 10 2005 041 540.7, filed Aug. 31, 2005, which is hereby incorporated by reference in its entirety.

### BACKGROUND OF THE INVENTION

1. Field of the Invention

The present invention present relates to an extendable load carrier for vehicles, in particular passenger vehicles.

2. Background Art

U.S. Pat. No. 3,488,077 discloses an extendable load carrier. Such a load carrier is designed as a telescopically extendable support device for camper attachments. The load carrier is provided at the level of the bumper at the rear end of a pickup vehicle. The load carrier is supported by a rear overhang, projecting backwards beyond the loading surface of the pickup vehicle, on the extended support device.

For fixing in position with respect to the vehicle structure, guide tracks in which longitudinally displaceable support members are mounted and which have guide profiles which are attachable to the vehicle structure are associated with the load carrier. The support members on their rear free ends support a bumper of the vehicle and are fixable to the guide profiles, and therefore also to the vehicle structure, by means of locking devices.

Proceeding from the outer guide profiles, the extendable support members are locked by means of socket pin systems. The socket pin systems engage with the bore matrices provided in the support members. As a result of the support members being guided via their extendable longitudinal sections into the surrounding guide profiles the support members may be occupied only in the extended state, but are not available for permanent installation of add-on parts.

Notwithstanding, guide profiles and support profiles must also be designed with relatively narrow mutual clearances. Otherwise, the locking bolts must at the same time assume support functions resulting in high localized stresses on the guide tracks. However, appropriately narrow clearances are critical from the standpoint of corrosion.

### SUMMARY OF THE INVENTION

An object of the present invention is to provide an extendable load carrier of the aforementioned type, such that the load carrier allows the permanent installation of add-on parts in the extendable region of the load carrier, and also that the load carrier is not critical from the standpoint of corrosion (which is of particular importance for the mounting of load carriers to passenger vehicles which often are not used for long periods depending on the time of year and which must be easily operable at any time, if needed, by inexperienced persons).

In carrying out the above object and other objects, the present invention provides an extendable load carrier for a motor vehicle. The load carrier includes a clamping device and two spaced-apart guide tracks. The guide tracks run parallel to a support plane. Each guide track has an inner guide profile and an outer support profile, the support profile being longitudinally displaceable with respect to the guide profile. The guide profile is fixable to a vehicle structure. The guide profile has a lower flange, a longitudinally slotted upper flange, and a longitudinal slot. The support profile is extendible and fixable in position with respect to the guide profile. The support profile has a U-shaped cross section including a bridge corresponding to the upper flange of the guide profile. The support profile overlaps the guide profile from above and the clamping device passes through the longitudinal slot in the guide profile such that the support profile and the guide profile are connected so as to braced and supported to one another by the upper flange and the bridge.

Accordingly, the present invention achieves the above-noted object by appropriate attachment of the guide profiles to the vehicle structure the inner profiles are used as guide profiles for the guide tracks. As such, the support profiles are available and usable for the attachment of installation parts—regardless of the requirement for the parts to be displaceable—to the guide profiles. The interspace between the guide tracks in particular also are available for such use so as to achieve a correspondingly flat structure. The flat structure due to space and function requirements is necessary when the load carrier is used as a rear extendable bicycle carrier on passenger vehicles. Such a design lends itself to advantageous possibilities in guiding and locking the support profiles with respect to the guide profiles, irrespective of sufficient clearances desirable from the standpoint of corrosion and soiling. It is also possible within the scope of the present invention to achieve the necessary locking between the guide profiles and support profiles by means of clamping devices having very small space requirements, and to advantageously place the clamping devices and operate same with little expenditure of force.

The design of the guide profile having a longitudinally slotted upper flange provided in conjunction with the clamping device makes it possible to make further use of the clamping device for transverse support of the support profiles. This may be desirable due to the rough clearances sought between the guide profile and the support profile. Furthermore, using simple parts and with little design and manufacturing complexity the clamping device may provide reinforcement for the transition region between the guide profile and the support profile. From the standpoint of strength, this is critical when the load carrier is extended. This is achieved by providing a stationary cover plate for the support profile and an inlaid counterplate for the guide profile which may be braced with respect to one another by means of the clamped connection of the clamping device passing through the longitudinal slot of the guide profile, the counterplate also improving transverse stability.

Within the scope of the present invention, the clamping force may be transmitted in a simple manner by means of a clamping pin which at the same time specifies the clamping axis, a corresponding clamping lock for the clamped connection advantageously forming the upper part of the clamped connection contacting the cover plate.

Within the scope of the present invention, a structure for the clamping lock is provided having a tension washer that is rotatable with respect to the clamping axis and having a counterpart. The tension washer and the counterpart are provided with sector-shaped deflector elements aligned with respect to one another in the clamping direction. The deflector elements are mutually separated by a gap and overlap in the clamping direction when the clamping lock is not tightened, and which preferably have a centrally symmetrical configuration with respect to the clamping axis, corresponding to the rotability of the tension washer. Whereas the tension washer is rotatable as an actuating element, the counterpart for the cover plate, i.e., the upper flange, of the support profile is stationary, and by appropriate configuration of these parts may be integrated therein. However, within the scope of the present invention it is preferred to design the counterpart as a separate component which is stationarily mounted on the cover plate or directly on the support profile, because according to the present invention, this allows counterparts of identical, usually disk-shaped, design to be aligned and positioned with respect to the respective support profile by appropriately offsetting the angle of rotation with respect to the clamping axis so that with regard to the particular associated support profile identical swivel regions, relative to the clamped and untightened position of the clamping lock, result for the tension washers.

It is also advantageous for the structure of the clamping lock for the tension washer, or the counterpart which likewise is basically disk-shaped, to be provided with a circumferential border so that the sector-shaped deflection elements are situated within a housing, so to speak, and are thereby protected. The housing also allows appropriate filling with lubricating grease.

With regard to the ease and robustness of manufacture of such a clamping lock, it has proven to be practical for the cooperating sector-shaped deflection elements associated with the tension washer and the counterpart to provide the deflection elements associated with the counterpart with three-dimensionally curved deflection surfaces. The deflection surfaces rise from a base plane and run in a clamping plane at a distance from the base plane. The distance between the base plane and the clamping plane in the overlap region between the sector-shaped deflection elements associated with the tension washer and with the counterpart corresponds to the achievable clamping range, and therefore also to the clamping range in the direction of the clamping axis achievable by means of the clamping lock.

In principle, it is within the scope of the present invention to provide the sector-shaped deflection elements on both the tension washer and the counterpart with deflection surfaces which run at an angle between the base plane and the clamping plane. However, a design is preferred in which the counterpart has corresponding three-dimensionally shaped sides. It is preferable for the rise of the deflection surfaces from the base plane to be relatively steep so that when the clamping lock is not tightened a centering effect is achieved over the sector-shaped deflection elements of the tension washer. On the other hand, a gentle slope of the deflection surfaces into the clamping plane is provided, thereby securing the clamping position defined in the clamping plane, in particular by frictional locking.

Actuation via a control lever has proven to be practical for the tension washer. The angle of rotation for the tension washer between the clamped and un-tightened position of the clamping lock preferably being approximately 90°. For the clamped position of the clamping lock, a position of the control lever is practical in which the control lever extends so as to overlap the respective guide track.

The clamping lock is braced against elastic force. The spring is completely rebounded in the un-tightened position of the clamping lock and the support profile rests against the guide profile with a force corresponding to the gravitational force of the support profile.

The space between the guide profile and the counterpart inserted therein provides sufficient play to allow longitudinal displacement between the support profile and the guide profile. This play is eliminated by bracing the clamping lock and the contact force is increased according to the spring characteristic curve of the disk spring and the support profile is fixed with respect to the guide profile.

In conjunction with the capability for longitudinal displacement of the load carrier provided in the un-tightened state of the clamping device, according to the present invention the load carrier is secured in the respective end position by means of a rotary latch. The rotary latch is spring-loaded at its locking position. As a result of the design of the rotary latch according to the present invention as a two-armed lever and the pretensioning at the locking position the rotary latch runs in two directions, i.e., in both the extension direction and the retraction direction of the extendable part of the load carrier, thereby allowing the extendable part of the load carrier to be locked.

Such a configuration is characterized by high operational reliability with a simple structural design. The rotary latch preferably is provided in the longitudinal center region between the guide tracks at a rear end region, relative to a rear extendable load carrier, of the part of the load carrier which is stationary with respect to the vehicle.

The above features, and other features and advantages of the present invention are readily apparent from the following detailed descriptions thereof when taken in connection with the accompanying drawings.

### BRIEF DESCRIPTION OF THE DRAWINGS

FIG. 1 illustrates an extendable load carrier according to the present invention in a perspective exploded illustration reduced to the basic structure of the carrier, having a support part that is stationary with respect to the vehicle and having a support part that is telescopically extendable with respect to the stationary support part;

FIG. 2 illustrates a top view of an extendable load carrier according to the present invention, with its essential components in the retracted state;

FIG. 3 illustrates an illustration corresponding to FIG. 2, with the load carrier extended;

FIG. 4 illustrates a view of the load carrier as illustrated in FIG. 3, viewed in the direction of the arrow IV;

FIG. 5 illustrates a simplified schematic sectional illustration of a load carrier according to FIG. 3 in a section along V-V, one of the clamping devices which lies in the sectional plane being shown in a simplified exploded illustration;

FIGS. 6 through 10 illustrate schematic illustrations in a partial sectional view of the clamping lock provided in conjunction with the clamping device; and

FIG. 11 illustrates a schematic illustration of a rotary latch arrangement by which the extendable part of the load carrier may be locked in its respective extended and retracted positions.

### DETAILED DESCRIPTION OF THE PREFERRED EMBODIMENT(S)

In the figures, reference numeral F denotes the forward direction of travel of a vehicle (not illustrated), for example and in particular a passenger vehicle. An extendable load carrier 1 is provided at the rear of the vehicle. Extendable load carrier 1 includes a stationary and structurally rigid part 16 and an extendable part 15. Extendable part 15 of load carrier 1 may be telescopically extended with respect to fixed part 16 of load carrier 1. Extendable part 15 of load carrier 1 is movable between retracted and extended positions with respect to fixed part 16 of load carrier 1.

Load carrier 1 includes spaced apart guide tracks 2, 3 which run parallel to one another. Guide tracks 2, 3 define a support plane 4 for load carrier 1 and run parallel to the support plane. Each guide track 2, 3 is formed by a respective guide profile 5 and a respective support profile 6.

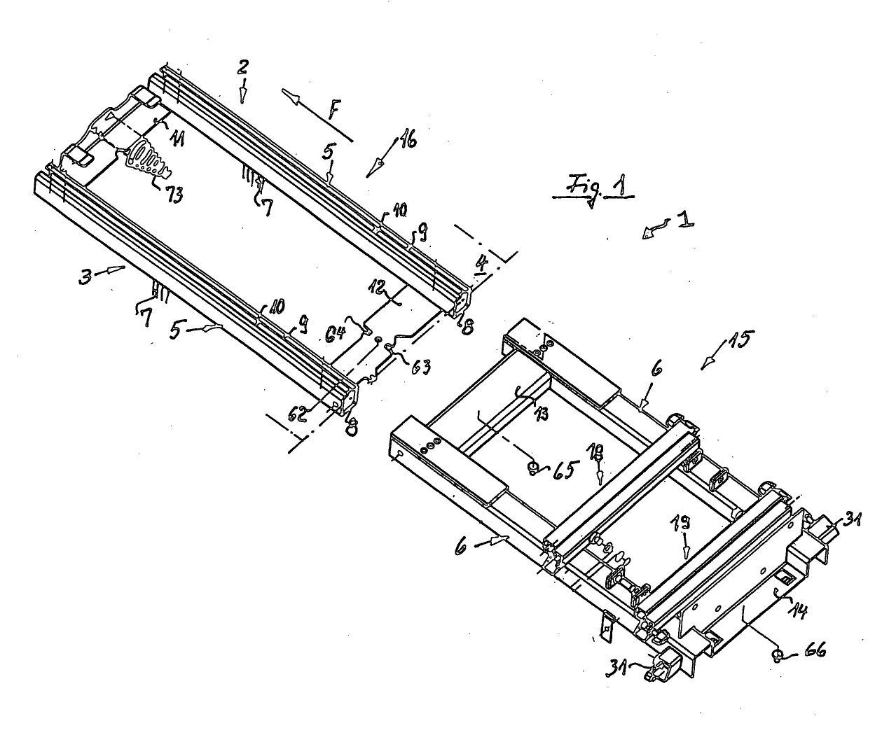

Guide profiles 5 are fixed to a vehicle structure 7 (indicated by cross-hatched lines in FIGS. 1 and 3) as inner profiles for guide tracks 2, 3. The fixing to vehicle structure 7 in the region of guide profiles 5 is achieved by corresponding clip arrangements or the like. Optionally, the fixing is also achieved by support profiles on the vehicle side which insert into guide profiles 5. Guide profiles 5 may be attached to structure 7 by means of clips or the like in the region of a lower flange 8 of each guide profile 5. Lower flange 8 is situated opposite to a respective upper flange 9 of guide profiles 5. Guide profiles 5 include a longitudinal slot 10. Transverse connections 11, 12 are provided on the end side between guide profiles 5. Support profiles 6, which are designed similar to guide profiles 5 as overlapping, in particular U-shaped, profiles, may be moved along guide profiles 5. Support profiles 6 likewise are connected via transverse struts 13, 14, resulting in a slot-shaped framework structure for extendable part 15 of load carrier 1.

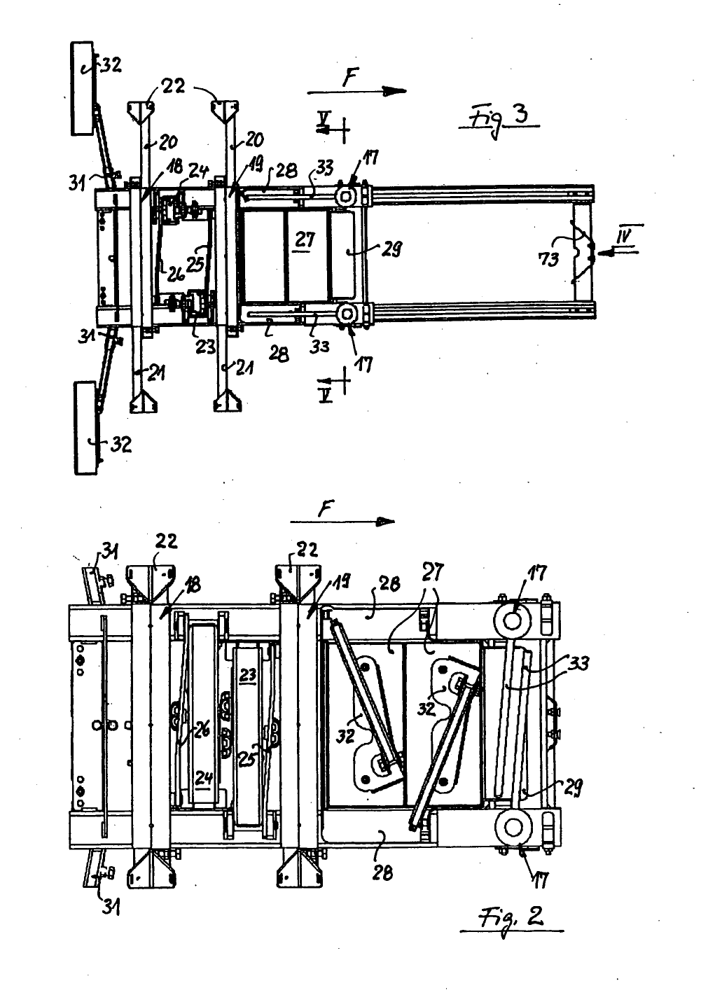

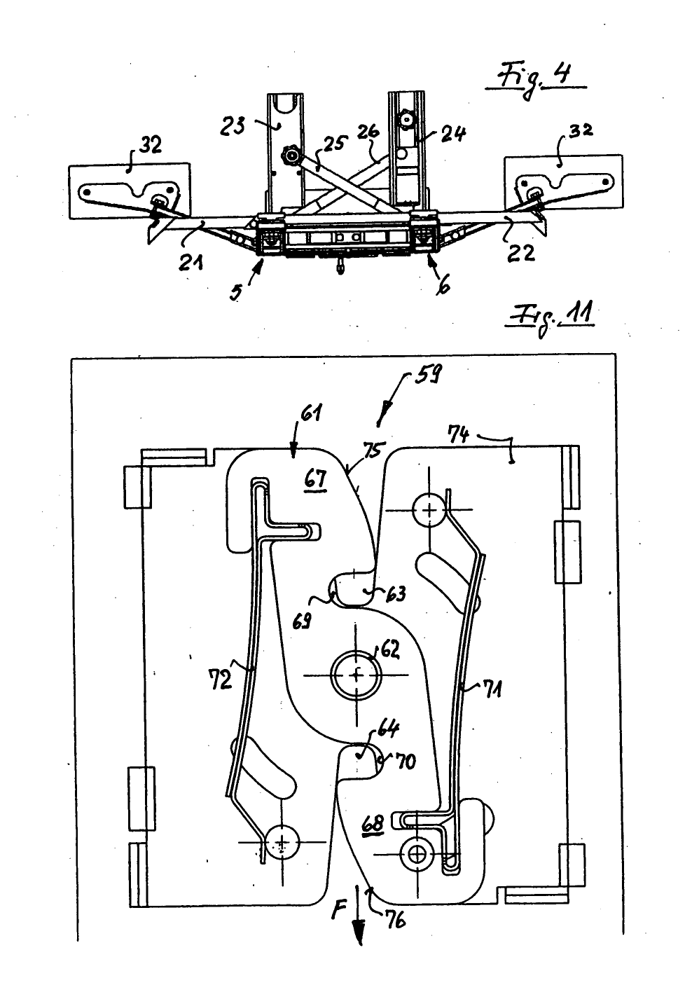

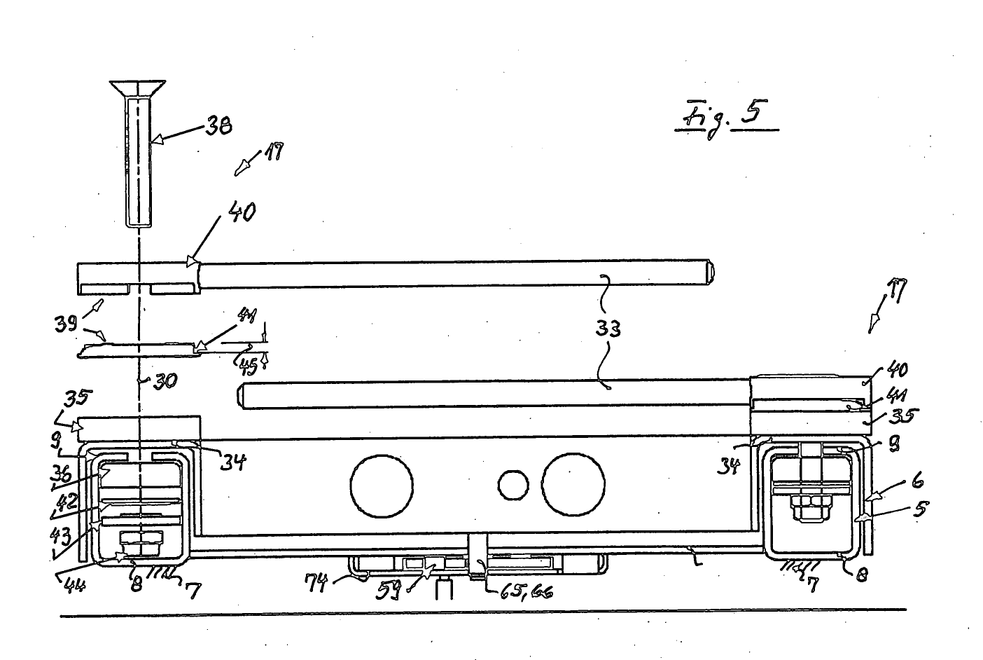

Extendable part 15 may be telescopically extended with respect to stationary and stationary part 16 which is fixed to structure 7. The retracted and the extended position of extendable part 15 is secured as an end position (not visible in FIG. 1) and extendable part 15 may also be fixed in the extended position with respect to stationary part 16 by a clamping device 17 (as illustrated in greater detail in FIG. 5). Extendable part 15 also supports installation or accessory parts for use as a bicycle carrier, as further described with reference to FIGS. 2 and 3.

As shown in FIGS. 1, 2, and 3, the fittings for extendable part 15 in the form of a bicycle carrier include two transverse guides 18, 19. Transverse guides 18, 19 are situated at a distance from one another and are stationary with respect to support profiles 6. Support profiles 6 form respective guide channels for beams 20, 21. Beams 20, 21 are extendable in the transverse direction toward opposite sides. Beams 20, 21 have supports 22 in the region of their free ends for the wheels of a bicycle to be placed thereon, transverse to the direction of travel F. For each of the bicycles (not shown) placed with its running wheels on holders 22, a frame bracket 23, 24 is also provided lateral to transverse guides 18, 19 in the interspace therebetween. Each frame brackets 23, 24 is linked to a respective support profile 6 so as to be pivotable in the transverse direction and pivotable between an upright supporting position (FIG. 3) and a stored position. In the stored position, frame brackets 23, 24 are swiveled in against one another between transverse guides 18, 19. Support struts 25, 26 which may be correspondingly swiveled and positioned are respectively associated with frame brackets 23, 24. Within the scope of the present invention the support struts may be formed by toggle levers, which in their extended position assume a dead center or an above dead center position and are folded together for storage.

Toward the front end, relative to the direction of travel F, of extendable part 15 of the bicycle carrier the portion of space between support profiles 6 adjoining transverse guide 19 is occupied by a drawer-like inlaid case 27. Inlaid case 27 is supported by exposed border strips 28 on support profiles 6 and a border strip 29 on transverse strut 13. Inlaid case 27 forms a stationary component of extendable part 15 and is preferably adhesively bonded to the surrounding framing.

Clamping devices 17 provided in the connection between support profiles 6 and guide profiles 5 are situated in the front end region, relative to the direction of travel, of extendable part 15.

On the opposite end of support profiles 6, the support profiles are provided with lateral receptacles 31 for lighting systems 32 to be placed at the rear of the vehicle which, as illustrated in FIG. 2, are removed for transferring load carrier 1 to its retracted unused position and are stored in inlaid case 27.

In the retracted position of load carrier 1, as illustrated in FIG. 2, load carrier 1 forms a very compact unit. Control levers 33 associated with clamping devices 17 likewise assume a transverse position. From this transverse position, which corresponds to the open position of clamping device 17, control levers 33 may be swiveled to clamp clamping device 17 in the positions parallel to respective guide tracks 2, 3 (illustrated in FIG. 3). As a result, control levers 33 extend against transverse guides 19 and thus opposite the direction of travel F. Optionally, control levers 33 are locked by means of an appropriate securing arrangement.

Clamping device 17 preferably has a structure according to FIG. 5. Clamping device 17 overlaps closed guide profile 5 up to longitudinal slot 10 and overlaps guide profile 5 and connects U-shaped support profile 6. Guide profile 5 and support profile 6 are to be braced against one another in the direction of clamping axis 30. Guide profile 5 together with upper flange 9 rest against bridge 34 of support profile 6 having a U-shaped cross section. Bridge 34, as the upper flange for support profile 6, is overlapped in the region of clamping device 17 by a cover plate 35. Cover plate 35 extends essentially over the end region of support profile 6, running in the direction of travel F. Cover plate 35 is fixedly connected to the support element, for example by welding, preferably as a reinforcing and stiffening support for a bridge 34. Corresponding to cover plate 35 is a counter-plate 36. Counter-plate 36 is situated inside guide profile 5 and may be moved along same. Counter-plate 36 preferably in the function of a sliding block is guided in a longitudinally displaceable manner between side walls 37 of guide profile 5. Counter-plate 36 is situated in the direction of cover plate 35 so as to overlap the arms of upper flange 9 which run into longitudinal slot 10.

Cover plate 35 is braced against counter-plate 36 by means of a clamping pin 38 which passes through clamping device 17 along clamping axis 30. Particularly, cover plate 35 is braced against counter-plate 36 by the use of a clamping lock 39 having a tension washer 40 and a disk-shaped counterpart 41 corresponding thereto, with respect to which tension washer 40 is shifted by twisting about clamping axis 30 in the direction of clamping axis 30. Disk-shaped counterpart 41 is stationarily braced with respect to cover plate 35. On one side clamping pin 38 is supported on tension washer 40 and is elastically braced against counter-plate 26 by means of a screw connection. For the purpose of a screw connection, a disk spring 42 is provided which in the direction opposite to counter-plate 36 is supported on a centering disk 43. In turn, centering disk 43 is supported against a tensioning nut 44 fixed to clamping pin 38. The spring excursion of disk spring 42 and the play between counter-plate 36 and guide profile 5 required to traverse extendable part 15 specify the clamping range available for bracing when clamping lock 39 is closed by twisting tension washer 40 against counterpart 41. In the exemplary embodiment this clamping range 45 (FIG. 5) corresponds to the distance between a base plane 46 of disk-shaped counterpart 41 and a clamping plane 47 offset with respect to the base plane in the direction of clamping axis 30 (FIG. 10).

In the exemplary embodiment shown, tension washer 40 has two sector-shaped deflector elements 48. Deflector elements 48 are diametrically opposed with respect to clamping axis 30. Deflector elements 48 project from disk plane 49 and extend in the direction of counterpart 41 when tension washer 40 is in the overlapping position with respect to the counterpart. Counterpart 41 has sector-shaped depressions 50. Depressions 50 correspond to sector-shaped deflector elements 48 relative to un-tightened clamping lock 39, which extend up to base plane 46 and which in the circumferential direction are bounded by deflection surfaces 52. Deflection surfaces 52 rise up from clamping plane 47. Deflection surfaces 52, as boundaries of deflection elements 53 provided by counterpart 41, merge into clamping plane 47, so that in the rotational positions of tension washer 40 with respect to counterpart 41, in which deflector elements 48 provided by tension washer 40 strike with their end faces against deflector elements 53 in clamping plane 57, a clamped position of the clamping lock comparable to a dead center position results, with a frictional-lock securing of the rotational position of tension washer 40 and counterpart 41. The angle of rotation provided for this purpose is approximately 90°, as illustrated by the position of control lever 33 according to FIGS. 2 and 3.

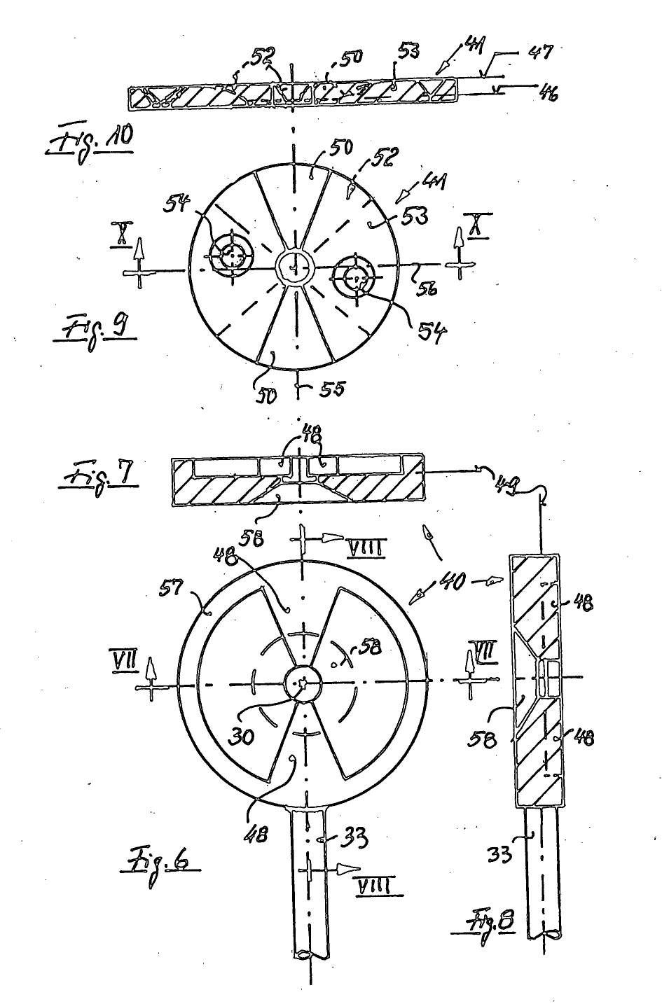

To allow the setting of control lever 33 seen in FIG. 2, which for a symmetrical configuration of clamping devices 17 with respect to the transverse plane is approximately opposite from the transverse plane, to operate with symmetrically designed counterparts 41, the counterparts are slightly shifted relative to the longitudinal extension of support profiles 6 which support them. The angular displacement in this regard is apparent from FIG. 9 from the position of screw holes 54. Screw holes 54 are provided for screwing counterpart 41 against cover plate 35 and are shifted toward a transverse plane 56 in the direction opposite to the axis of symmetry 55.

In the exemplary embodiment, tension washer 40 is provided with a circumferential edge 57. The inner diameter of edge 57 essentially corresponds to the diameter of the plate which forms counterpart 41 such that clamping lock 39 represents a unit basically externally surrounded on the edges by tension washer 40. Control lever 33 also starts from edge 57. Clamping pin 38 may be positioned so as to engage with its head part in an indentation 58. As a result, a very flat structure for clamping lock 39 including control lever 53 consistent with the height of the entire load carrier 1 is obtained.

It is also within the scope of the present invention for the clamping device, which has basically the same design, as well as the clamping lock in particular to be acted on by an actuator. This also allows remote actuation which optionally may be combined with an appropriate drive system for the axial displacement of load carrier 1, resulting in further simplification in operation of load carrier 1 within the scope of the present invention.

Notwithstanding, it has proven to be practical for the possible end positions for load carrier 1—extended or retracted—to be secured by means of a mechanical lock. Within the scope of the present invention, the mechanical lock is designed so that the lock is automatically achieved when the respective end position is reached. According to the present invention, for this purpose a rotary latch system 59 is associated with guide profiles 5 in the region of their rear part opposite the direction of travel F (as illustrated in FIG. 11). Rotary latch system 59 (with reference to FIG. 1) is supported by transverse connection 12. Transverse connection 12 has a central bearing hole 62 for rotary latch 61. Transverse connection 12 is also provided with guide openings 63, 64. Guide openings 63, 64 open in the directions of retraction and extension of extendable part 15 of load carrier 1. Guide openings 63, 64 with locking members 65, 66 corresponding to rotary latch 61 are associated for extendable part 15 of load carrier 1. In the exemplary embodiment locking members 65, 66 are formed by locking bolts. The locking bolts are on the underside of transverse struts 13, 14 and situated in the vertical direction in the path of intersection of guide openings 63, 64.

Rotary latch system 59 (schematically illustrated in a sectional view in FIG. 11) has a rotary latch 61. Rotary latch 62 is designed as a double lever having lever arms 67, 68 extending on both sides of bearing hole 62 relative to the direction of travel F. Lever arms 67, 68 are provided with intercepting jaws 69, 70. Intercepting jaws 69, 70 open toward opposite sides, transverse to the direction of travel F. Intercepting jaws 69, 70 relative to the locking position of rotary latch 61 overlap with guide openings 63, 64 extending in the direction of travel F. These guide openings in the illustration according to FIG. 11 are shown in a covering 74 for rotary latch system 59 which may be fixed to transverse connection 12, for corresponding overlaps for guide openings 63, 64 for this transverse connection shown in FIG. 1.

As shown in FIG. 11, in the locked position of rotary latch 61 intercepting jaws 69, 70 overlap guide openings 63, 64 in such a way that by means of rotary latch 61 locking member 65, 66 engaged thereby is fixed in guide opening 63, 64. Rotary latch 61 is elastically pre-tensioned relative to this locked position, which in the exemplary embodiment according to FIG. 1 is illustrated by leaf spring systems 71, 72. Rotary latch 61 may be deflected in the opposite direction via locking members 65, 66 as the result of impingement on deflection surfaces 75, 76 of the leaf springs. In addition, rotary latch 61 may be swiveled against the spring-loaded locked position into an unlocked position by means of remote actuation (not illustrated), such as a Bowden cable connection, so that in addition to an automatic locking in the respective end position of extendable part 15, locking may be performed in a simple manner even under unfavorable access conditions while unlocking from the outside, for example by unauthorized persons, is possible only with great difficulty.

In particular in conjunction with the unlocking possibilities addressed for load carrier 1 for a retractable and extendable load carrier part 15, it has been shown to be practical for extendable load carrier part 15 to be spring-loaded in the direction of extension, by means of an ejector 73. As a result, if the retracted end position secured by rotary latch system 59 is detached, a certain displacement of extendable load carrier part 15 occurs in the direction of opening. This displacement allows good access to extendable load carrier part 15, even when this part in its retracted position is protected from access by means of a cover, in particular a masking plate. Ejector 73 is symbolically represented as a helical spring in FIG. 1, and in a customary manner for drawers or the like may also be designed as a curved leaf spring (FIGS. 3 and 4) or the like.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. An extendable load carrier for a motor vehicle, the load carrier comprising:
a clamping device; and
two spaced-apart guide tracks running parallel to a support plane, each guide track having an inner guide profile and an outer support profile, the support profile being longitudinally displaceable with respect to the guide profile;
the guide profile being fixable to a vehicle structure, the guide profile having a lower flange, a longitudinally slotted upper flange, and a longitudinal slot;
the support profile being extendible and fixable in position with respect to the guide profile, the support profile having a U-shaped cross section including a bridge corresponding to the upper flange of the guide profile;
wherein the support profile overlaps the guide profile from above and the clamping device passes through the longitudinal slot in the guide profile such that the support profile and the guide profile are connected so as to braced and supported to one another by the upper flange and the bridge.

2. The load carrier of claim 1 wherein:
the clamping device guides the support profile transverse to the guide profile.

3. The load carrier of claim 1 wherein:
the clamping device includes a counter-plate, the counter-plate is inlaid relative to the guide profile, wherein by running through the longitudinal slot in the guide profile the clamping device supports the counter-plate against the bridge of the support profile.

4. The load carrier of claim 3 wherein:
the support profile includes a reinforcing cover plate on the side of the bridge of the support profile, the reinforcing cover plate is associated with the counter-plate.

5. The load carrier of claim 2 wherein:
the clamping device includes a clamping pin and a clamping lock, the clamping pin passes through the longitudinal slot of the guide profile, the clamping pin determines a clamping axis and forms a guide for a clamping lock.

6. The load carrier of claim 5 wherein:
the clamping lock includes a tension washer and a counterpart, the tension washer is rotatable with respect to the clamping axis, wherein the tension washer and the counterpart include sector-shaped deflector elements aligned with one another in the clamping direction, mutually separated by a gap, and overlapping in the clamping direction when the clamping lock is not tightened.

7. The load carrier of claim 6 wherein:
the deflector elements have a centrally symmetrical configuration with respect to the clamping axis.

8. The load carrier of claim 6 wherein:
the deflector elements, proceeding from a base plane perpendicular to the clamping axis corresponding to a starting position of a clamping lock in an un-tightened state, have a deflection surface on at least one of their sides which merges into a clamping plane separated at a distance from the base plane.

9. The load carrier of claim 8 wherein:
the clamping plane is connected to the base plane by the deflection surface running at least essentially perpendicular to the clamping axis.

10. The load carrier of claim 8 wherein:
the deflection surface runs into the clamping plane.

11. The load carrier of claim 7 wherein:
the deflection surface adjacent to the base plane has an inclined, generally flat, course with respect to the vertical which rises steeply with respect to the base plane.

12. The load carrier of claim 8 wherein:
the deflector elements have a perpendicular course with respect to the base plane on sides corresponding to sides formed by the deflection surfaces.

13. The load carrier of claim 6 wherein:
the deflector elements of the tension washer and the counter-part strike one another with their sides in the region of the base plane when the clamping lock is not tightened so as to limit the angle of rotation.

14. The load carrier of claim 6 wherein:
the counterpart is a counter-disk.

15. The load carrier of claim 6 wherein:
the counterpart is stationary with respect to the support profile.

16. The load carrier of claim 15 wherein:
the counterpart is a counter-disk to be attached to the support profile in rotationally shifted positions.

17. The load carrier of claim 1 wherein:
the support profiles are associated with an extendable part of the load carrier, the extendable part being lockable in one of a retracted and extended position by a rotary latch, the rotary latch being spring-loaded at its locking position.

18. The load carrier of claim 17 wherein:
the guide profiles are associated with a structurally fixed part of the load carrier, the rotary latch being associated with the structurally fixed part.

19. The load carrier of claim 17 wherein:
the rotary latch is provided at the front end region, relative to the direction of extension of the load carrier from the structurally fixed part, the rotary latch having a two-armed lever, the rotary latch being situated in the traversed path of the extendable part and which in the region of its opposite ends is respectively associated with one locking member corresponding to the rotary latch.

20. The load carrier of claim 19 wherein:
the locking member is a locking bolt.

21. The load carrier of claim 19 wherein:
the two-armed lever of the rotary latch extends in the direction of extension of the load carrier, and in the lever arms of the two-armed lever which are oppositely situated with respect to a rotational axis thereof is provided with intercepting jaws which open toward opposite sides.

22. The load carrier of claim 21 wherein:
the rotary latch includes deflection surfaces running into the opening of the respective intercepting jaw.

23. The load carrier of claim 20 wherein:
the openings in the intercepting jaw are hook-shaped and are situated so as to overlap with a guide opening.
